(19) United States
(12) Patent Application Publication
(10) Pub. No.: US 2009/0154961 A1
(43) Pub. Date: Jun. 18, 2009

(54) DEVELOP UNIT, PROCESS CARTRIDGE, AND IMAGE FORMATION APPARATUS

(76) Inventors: Noriyuki KAMIYA, Yamato-shi (JP); Kyohta Koetsuka, Fujisawa-shi (JP); Yoshiyuki Takano, Tokyo (JP); Tadaaki Hattori, Hadano-shi (JP); Mieko Terashima, Isehara-shi (JP); Masayuki Ohsawa, Atsugi-shi (JP); Rei Suzuki, Atsugi-shi (JP); Hiroya Abe, Yokohama-shi (JP); Takashi Innami, Atsugi-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/329,826

(22) Filed: Dec. 8, 2008

(30) Foreign Application Priority Data
Dec. 14, 2007 (JP) 2007-322984

(51) Int. Cl. G03G 15/09

(52) U.S. Cl. 399/275

(57) ABSTRACT

A develop unit is configured to include a developer roller having a developer sleeve and a magnetic roller with a magnetic pole, a supply path formed in parallel with an axial direction of the developer roller, a supply screw supplying the developer to the developer roller, and a first bulkhead forming the supply path. In the developer unit, the magnetic pole is disposed so that a normal line through a maximum magnetic flux density point in a circumferential direction coincides with a tangent line to an upper portion of the supply screw in a rotary direction, the maximum magnetic flux density point being a point at which a density of a magnetic flux from the magnetic pole is maximum on an outer surface of the developer sleeve.

### CROSS REFERENCE TO RELATED APPLICATION

The present application is based on and claims priority from Japanese Patent Application No. 2007-322984, filed on Dec. 14, 2007, the disclosure of which is hereby incorporated by reference in its entirety.

### BACKGROUND OF THE INVENTION

1. Field of the Invention

The present invention relates to a develop unit and a process cartridge used in an image formation apparatus such as a copier, a facsimile, or a printer, and such an image formation apparatus. In particular, it relates to a develop unit using a two-component developer made of a toner and a magnetic carrier, a process cartridge incorporating such a develop unit, and an image formation apparatus incorporating such a process cartridge.

2. Description of the Related Art

In the prior art, there have been various improvements in a develop unit using a two-component developer (hereinafter, developer) made of a toner and a magnetic carrier in order to attain a developed image with an even density and prevent unevenness or a decrease in the density of developed images.

For example, Japanese Laid-open Patent Application Publication No. 2007-101797 discloses a develop unit 610 in FIG. 11 which comprises a developer support body 611 composed of a cylindrical hollow body 612 (developer sleeve) holding a developer on its outer surface, a magnetic field generator 613 (magnetic roller) contained in the hollow body 612 and including a magnetic pole absorbing the developer onto the outer surface; a developer supply path 614 disposed in parallel with the developer support body 611 (developer roller) at the same height in axial direction; a developer supply member 615 (supply screw) in a spiral form disposed in the developer supply path 614 and rotating to carry and supply the developer to the developer support body 611 in the axial direction; a bulkhead 620 forming the developer supply path 614 with one end 620a extending along the developer support body 611 with a gap; a developer recovery path 616 disposed below the developer support body 611 to recover a used developer; a developer recovery member 617 (supply screw) in a spiral form placed in the developer recovery path 616 to carry the recovered developer in one direction; a developer agitation path 618 disposed in parallel with the developer recovery path 616 to agitate the recovered developer to make density thereof uniform, and a developer agitation member 619 (agitation path) in a spiral form disposed in the developer agitation path 618 to agitate the developer. The developer supply path 614 is provided obliquely upward the developer agitation path 618. Also, a photoconductor drum 601 is provided to face the developer support body 611.

With the provision of the developer recovery path 616, this develop unit 610 can prevent the used developer from being reused immediately after developing and maintain uniform density of the developer supplied to the developer support body 611. Further, because the developer supply path 614 is provided obliquely upward the developer agitation path 618, it is possible to reduce an amount of stress applied to the developer when the developer is carried from the developer agitation path 618 to the developer supply path 614. This leads to increasing the longevity of the developer and preventing variation in the density of a developed image over time accordingly.

However, the develop unit 610 disclosed in the above document has a problem that an area in which the outer surface of the developer support body 611 face the developer supply path 614 is reduced since they are placed at the same height, and the bulkhead 620 is provided with the one end 620a in parallel with the developer support body 611 with a gap to prevent the developer from leaking from the developer supply path 614. Therefore, a magnetic pole which is provided to absorb the developer onto the surface of the developer support body 611 is required to have sufficient magnetic force to absorb a desired amount of developer, even if the area of the developer support body 611 facing the developer supply path 614 is small.

In view of solving the above problem, the inventors of the present invention found that a positional relation between the magnetic pole of the developer support body and the developer supply member affected developer carrying performance in the axial direction of the developer supply path and the amount of developer absorbed onto the developer support body.

Specifically, the inventors of the present invention disposed a magnetic pole 625 to face the developer supply member 615 as shown in FIG. 12, and found out that a magnetic force of the magnetic pole 625 acted on the developer in the developer supply path too strongly and attracted the developer onto the developer support body 611 strongly. As a result of this, the developer was accumulated upstream of the carrier direction of the developer supply path 614 and not carried to the downstream, deteriorating the developer carrying performance. Unbalance of the amount of the developer supplied to the upstream and downstream of the developer support body 611 resulted in uneven density of a developed image in the axial direction of the developer support body 611.

In contrast, when the magnetic pole 625 is disposed downstream of a rotary direction of the developer support body 611 so as not to face the developer supply member 615 as shown in FIG. 13, the magnetic force of the magnetic pole 625 to the developer was weakened and the developer carrying performance improved, preventing accumulation of the developer in the developer supply path 61. However, a magnetic force to attract the developer to the developer support body 611 is also weakened, making it impossible to absorb a desired amount of the developer thereonto, and thereby decreasing the density of a developed image.

### SUMMARY OF THE INVENTION

In view of solving the above problems, the present invention aims to provide a develop unit in which a developer supply member and a magnetic pole are optimally positioned relative to each other and which can form images without density failures. The present invention also aims to provide a process cartridge incorporating such a developer unit and an image formation apparatus incorporating such a process cartridge.

According to one aspect of the present invention, a develop unit is configured to include a developer support body comprising a cylindrical hollow body supporting a developer on its outer surface, a magnetic field generator contained in the hollow body and including a magnetic pole absorbing the developer onto the outer surface, the developer being made of a toner and a magnetic carrier; a developer supply path formed in parallel with an axial direction of the developer support body; a developer supply member disposed in the developer supply path and rotating to carry and supply the developer to the developer support body in the axial direction; and a bulkheading member forming the developer supply path with one end extending along the developer support body with a gap, wherein the magnetic pole is disposed in the magnetic field generator so that a normal line through a maximum magnetic flux density point in a circumferential direction coincides with a tangent line to an upper portion of the developer supply member in a rotary direction, the maximum magnetic flux density point being a point at which a density of a magnetic flux from the magnetic pole is maximum on an outer surface of the hollow body.

In features of this aspect, the magnetic pole is disposed in the magnetic field generator so that an upstream minimum magnetic flux density point is to be closer to an upstream of a rotary direction of the developer support body than one end of the bulkheading member, the upstream minimum magnetic flux density point being one of minimum magnetic flux density points at an upstream of the rotary direction of the developer support body, the minimum magnetic flux density points being points at which densities of magnetic fluxes from the magnetic pole are minimum on the outer surface of the hollow body.

In other features of this aspect, the magnetic field generator comprises an auxiliary magnetic pole disposed at a position closer to the upstream of the rotation direction of the developer support body than the one end of the bulkheading member.

In other features of this aspect, a mean particle size of the magnetic carrier is 20 μm or more and 50 μm or less.

According to another aspect of the present invention, a process cartridge is configured to include the above-described develop unit.

According to another aspect of the present invention, an image formation apparatus is configured to include one or more process cartridge(s) described above.

### BRIEF DESCRIPTION OF THE DRAWINGS

FIG. 1 is a cross sectional view of a develop unit according to a first embodiment (first example) of the present invention;

FIG. 2 is a perspective view of the develop unit of FIG. 1, showing a flow of a developer;

FIG. 3 is a pattern diagram showing the flow of the developer in the develop unit of FIG. 1;

FIG. 4 is a cross sectional view of a process cartridge according to a second embodiment of the present invention;

FIG. 5 is a cross sectional view of an image formation apparatus according to a third embodiment of the present invention;

FIG. 6 is a cross sectional view of a second example of a develop unit;

FIG. 7 is a cross sectional view of a third example of a develop unit;

FIG. 8 is a cross sectional view of a fourth example of a develop unit;

FIG. 9 is a cross sectional view of a develop unit as a first comparison;

FIG. 10 is a cross sectional view of a develop unit as a second comparison;

FIG. 11 is a cross sectional view of a prior art develop unit;

FIG. 12 shows that a magnetic pole is disposed to face a developer supply member in the prior art developer unit; and

FIG. 13 shows that a magnetic pole is disposed downstream of a developer support body in the prior art developer unit.

### DETAILED DESCRIPTION OF THE PREFERRED EMBODIMENTS

Hereinafter, embodiments of the present invention will be described in detail with reference to the accompanying drawings.

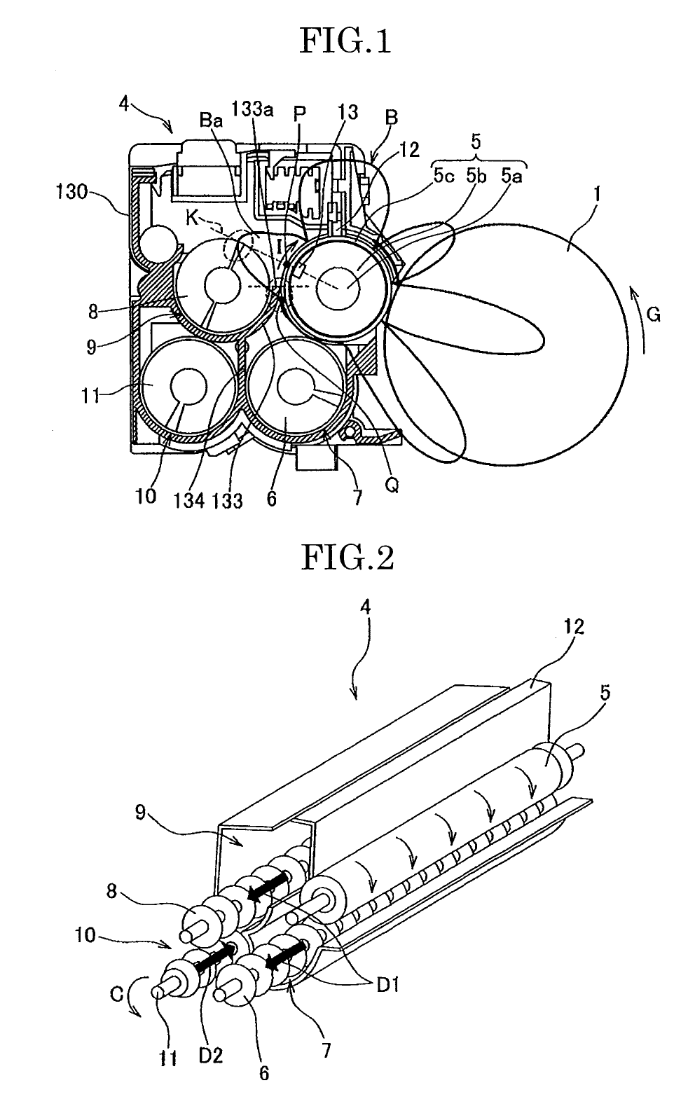

A develop unit, a process cartridge, and an image formation apparatus (color laser copier) according to the present invention will be described with reference to FIGS. 1 to 5.

The develop unit according to the first embodiment of the present invention will be described with reference to FIG. 1.

The develop unit 4 in FIG. 1 comprises a developer roller 5, a supply path 9, a supply screw 8, an agitation path 10, an agitation screw 11, a recovery path 7, a recovery screw 6, a first bulkhead 133, a second bulkhead 134, and a doctor blade 12 which are disposed in a case 130 of the develop unit 4. A photoconductor drum 1 in FIG. 1 is a component of a later-described process cartridge 18.

The developer roller 5 (developer support body) supports a two-component developer (hereinafter, developer) made of a toner and a magnetic carrier on its outer surface and carries the developer to the photoconductor drum 1. It is comprised of a metal core 5a, a magnetic roller 5b, and a developer sleeve 5c in a cylindrical form. Also, the outer surface thereof is partially exposed from an opening of a side face of the case 130 of the develop unit 4 so as to face the photoconductor drum 1.

The metal core 5a is a center of the axis of the developer roller 5 and made of a metal with high rigidity in a long cylindrical form. It is not rotatable and fixed to the case 130 at both ends.

The magnetic roller 5b (magnetic field generator) in cylindrical form is made of a magnetic material and it is non-rotatably fixed to the metal core 5a so that an axis thereof coincides with that of the metal core 5a. The magnetic roller 5b comprises a plurality of grooves on its surface in the axial direction which are disposed with an interval in a circumferential direction. A plurality of fixed magnetic poles are arranged in the grooves, which will be described for detail later.

The developer sleeve 5c (hollow body) is an aluminum base tube in a cylindrical form and has a length of 332 mm, an outer diameter of 25 mm, and an inner diameter of 23.4 mm. It is rotatably disposed in the periphery of the magnetic roller 5b to contain it. It includes a V-groove on its surface or the surface is roughened to absorb (hold) the developer. The developer sleeve 5c or the developer roller 5 rotates in a rotary direction I to carry the developer to the photoconductor drum 1. The developer sleeve 5c can be also made of a non-magnetic material such as a stainless steel, for example.

The supply path 9 (developer supply path) is formed in parallel with the developer roller 5 in the axial direction. The first bulkhead 133 is formed in a part of the case 130 to have a U-shape cross section and form the supply path. The bottom end of the developer roller 5 and the bottom of the U-shape cross section are almost at the same height. The supply path 9 accommodates the developer and comprises a supply screw 8 in a spiral form which is formed along with the shape of the supply path 9.

The supply screw 8 (developer supply member) is disposed to face the developer roller 5 so that the rotary axis thereof is in parallel with that of the developer roller 5 at the same height. The supply screw 8 rotates around the axis to carry the developer in the supply path 9 in a direction D1 in FIG. 2 (from a back side to a front side in the drawing) and supply it to the developer roller 5.

The agitation path 10 is formed by forming a part of the bottom portion of the case 130 positioned obliquely below the supply path 9 to have a U-shape cross section, so that a longitudinal direction thereof is parallel to that of the supply path 9. The agitation path 10 accommodates the developer and comprises an agitation screw 11 in a spiral form which is formed along with the shape of the agitation path 9. One end (upstream side) of the agitation path 10 is connected with a not-shown toner container to replenish the agitation path 10 with a toner while the other end (downstream side) thereof is provided with a not-shown toner density sensor to measure density of the toner. The toner container supplies the toner to the one end of the agitation path 10 according to the density of the developer measured by the density sensor, when appropriate.

The agitation screw 11 is disposed in the agitation path 10 so that the rotary axis direction thereof is parallel to that of the supply screw 8. It rotates around the rotary axis to agitate the developer in the agitation path 10 and the toner from the toner container and carry them in a direction D2 in FIG. 2 (from a front side to a back side of the drawing).

The recovery path 7 is formed by forming a part of the bottom portion of the case 130 positioned below the developer roller 5 to have a U-shape cross section, so that a longitudinal direction thereof is parallel to that of the agitation path 10. The recovery path 7 accommodates a used developer and comprises a recovery screw 6 in a spiral form which is formed along the shape of the recovery path 7.

The recovery screw 6 is disposed in the recovery path 7 so that the rotary axis direction thereof is parallel to that of the agitation screw 11. It rotates around the rotary axis to recover the used developer dropped from the outer surface of the developer roller 5 and carry it in the direction D1.

The supply screw 8, agitation screw 11, and recovery screw 6 are formed in the same shape and size using a synthetic resin. Their length is 330 mm, screw diameter is 18 mm, and screw pitch is 25 mm. The respective screws are rotated by a not-shown motor at a rotation speed of about 600 rpm in developing operation.

The first bulkhead 133 (bulkheading member) forms the supply path 9 and is a wall to separate the supply path 9, agitation path 10, and recovery path 7 and form independent spaces therebetween. The first bulkhead 133 comprises an opening to make the supply path 9 and agitation path 10 in communication with each other at their both ends but not to make the supply path 9 and recovery path 10 in communication with each other. One end 133a of the first bulkhead 133 is positioned between the supply screw 8 and the developer roller 5 in parallel with them. There is a gap of about 0.7 mm between the developer roller 5 and the one end 133a. With a larger gap therebetween, the developer in the supply path 9 leaks in the recovery path 7, reducing the amount of the developer over time to decrease density of developed images. Meanwhile, with a smaller gap therebetween, the first bulkhead 133 may get in contact with the developer roller 5 and damage the outer surface thereof. Further, height of the one end 133a of the first bulkhead 133 is the same as that of the rotary axis of the developer roller 5.

The second bulkhead 134 is a wall to separate the agitation path 10 and the recovery path 7 and form independent spaces therebetween. It comprises an opening to make one end of the recovery path 7 in communication with the one end of the agitation path 10.

The doctor blade 12 is fixed to the case 130 of the develop unit 4 so as to face the upper portion of the developer roller 5 with a gap of 0.3 mm. It removes an extraneous developer from the surface of the developer roller 5 to adjust a thickness of the developer properly.

The developer is a two-component developer made of a toner and a magnetic carrier as described above. The toner of the developer is fine spherical particles manufactured by emulsion polymerization or suspension polymerization. The toner can be manufactured by grinding a lump of synthetic resin in which various dyes or pigments are mixed and dispersed. The mean particle size of the toner is 3 μm or more and 7 μm or less. The magnetic carrier of the developer comprises a spherical core made of a magnetic body and a resin film covering the surface of the core, and the mean particle size thereof is 20 μm to 501 μm. Using the magnetic carrier of 20 μm to 50 μm of the mean particle size, images with solid granularity over time are producible.

Next, the plurality of fixed magnetic poles in the magnetic roller 5b will be described.

The fixed magnetic poles are long magnets whose lengths are the same as that of the magnetic roller 5b in the axial direction, and they are fitted in the grooves of the surface of the magnetic roller 5b. Specifically, the magnetic pole 13 for absorption (N-pole), a first magnetic pole for adjustment (S-pole), a second magnetic pole for carrier (N-pole), a third magnetic pole for development (S-pole), a fourth magnetic pole for recovery (N-pole) are arranged in this order in the rotary direction I of the developer roller 5 (only the magnetic pole 13 is shown in the drawing). Note that the curve B in FIG. 1 represents a magnitude (absolute value) of density of magnetic flux from each fixed magnetic pole on the outer surface of the developer roller 5 which directs to a normal line direction. As the curve B is distant away from the outer surface, the magnetic flux density increases. In particular, the curve Ba represents a magnitude of density of magnetic flux generated from the magnetic pole 13.

The magnetic pole 13 generates a magnetic force on the surface of the developer roller 5 and absorbs the developer from the supply path 9 onto the developer roller 5. As shown in FIG. 1, the magnet pole 13 is disposed so that a normal line K through a position P (maximum magnetic flux density point) in a circumferential direction coincides with a tangent line to an upper portion of the supply screw 8 in a rotary direction. The position P is a point at which a density of a magnetic flux from the magnetic pole 13 is maximum on the outer surface of the developer roller 5.

Also, as shown in FIG. 1, the magnetic pole 13 is disposed so that a position Q (upstream minimum magnetic flux density point) is to be closer to an upstream of a rotary direction I of the developer roller 5 than one end 133a of the first bulkhead 133. The position Q is one of minimum magnetic flux density points at an upstream of the rotary direction I of the developer roller 5. The minimum magnetic flux density points are points at which densities of magnetic fluxes from the magnetic pole 13 are minimum on the outer surface of the developer roller 5.

Disposing the magnetic pole 13 in such a manner makes it possible to make a magnetic force from the magnetic pole 13 optimally act on the developer in the supply path 9 and to achieve good developer carrier performance in the axial direction of the developer roller 5 and absorb a desired amount of the developer thereon. Furthermore, the magnetic force from magnetic pole 13 acts on even a portion below the one end 133a of the first bulkhead 133 and attracts the developer therein to the outer surface of the developer roller 5. It is therefore preventable of a reduction of the amount of the developer in the supply path 9 due to a leakage from the gap between the one end 133a and the developer roller 5. Accordingly, it is able to prevent unevenness in density of a developed image in the axial direction of the developer roller 5 and a decrease in the density of developed images.

In addition to the magnetic pole 13, the fixed magnetic poles include (a) the first magnetic pole disposed to face the doctor blade 12 and adjust a thickness of the developer on the developer roller 5 to a proper thickness together with the doctor blade 12, (b) the second magnetic pole disposed between the first and third magnetic poles to hold the developer in the proper thickness on the developer roller 5 and carry it to a develop area which is formed between the developer roller 5 (or third magnetic pole) and the photoconductor drum 1, (c) the third magnetic pole disposed to face the photoconductor drum 1, generate a magnetic force therebetween, form a magnetic brush from the magnetic carrier of the developer, and thereby deliver the toner to the photoconductor drum 1, and (d) the fourth magnetic pole disposed adjacent to the second magnetic carrier in a downstream of the rotary direction I of the developer roller 5, to generate a weak magnetic force in cooperation with the magnetic pole 13 in an area which opposes the recovery path 7, and to thereby recover a used developer from the developer roller 5. In the present embodiment, the respective magnetic poles are long magnets fitted in the magnetic roller, however, the present invention is not limited thereto. The magnetic roller itself can be magnetized to realize the magnetic poles.

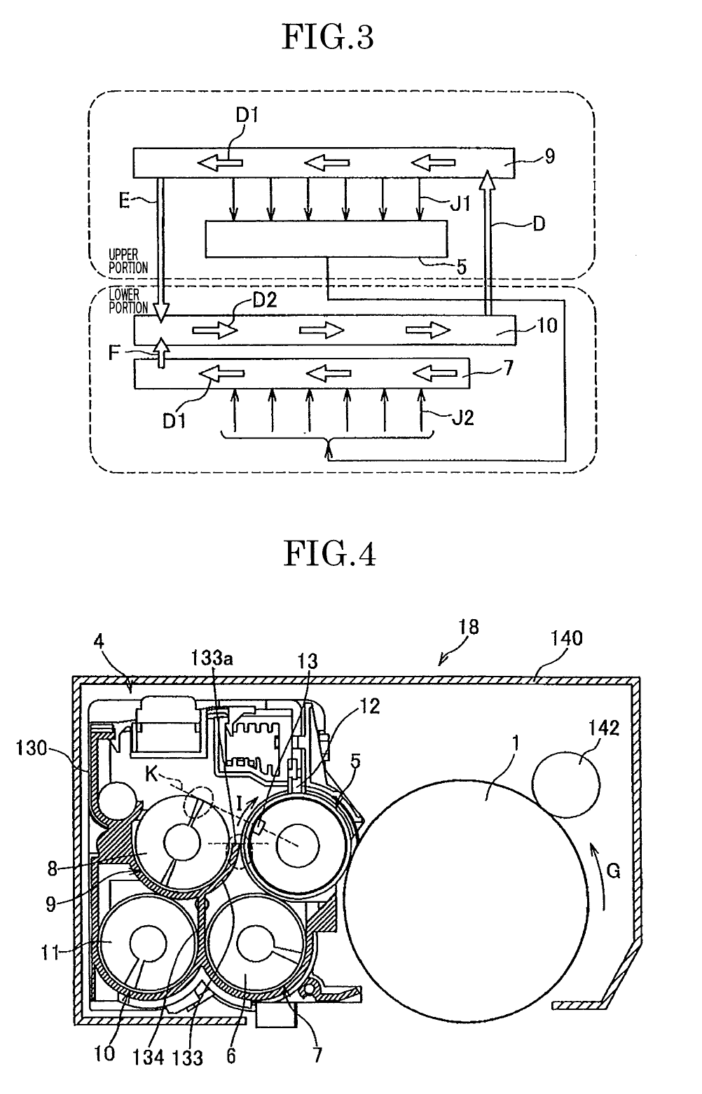

Next, the developing operation of the develop unit 4 (flow of the developer) will be described with reference to FIGS. 2, 3.

At start of a development, the develop unit 4 rotates the developer roller 5, supply screw 8, recovery screw 6, and agitation screw 11 by not-shown motors at respective rotation speeds in respective rotary directions.

The supply screw 8 carries the developer in the supply path 9 to the direction D1. The developer roller 5 absorbs a part of the developer on the surface thereof by the magnetic pole 13 (arrow J1 in FIG. 3). The supply screw 8 carries a remnant developer not absorbed on the developer roller 5 to a downstream end of the supply path 9 and supply it to the agitation path 10 via the opening (arrow E).

The developer roller 5 holds the absorbed developer on the surface and carries it to the develop area after the doctor blade 12 adjusts (limits) the thickness thereof. The developer in the develop area forms chain-like clusters or a magnetic brush on the surface of the developer roller 5 by the third magnetic pole. Then, the toner of the developer is separated from the magnetic brush and absorbed onto an electrostatic latent image on the photoconductor drum 1. The developer roller 5 carries a used developer to an area which is downstream of the develop area and drops it into the recovery path 7 (arrow J2 in FIG. 3).

The recovery screw 6 carries the used developer from the recovery path 7 in the direction D1 and supplied it to the agitation path 10 via the opening (arrow F).

The agitation screw 11 agitates the developer from the supply path 9, the used developer from the recovery path 7 and the toner supplied from the toner container, carries them in the direction D2 and supplies them to the supply path 9 via the opening (arrow D). The develop unit 4 repetitively performs the above operation for development.

According to the present invention, the magnet pole 13 is disposed so that the normal line K through the position P (maximum magnetic flux density point) coincides with a tangent line to an upper portion of the supply screw in a rotary direction. This make it possible to make a magnetic force from the magnetic pole 13 optimally act on the developer in the supply path 9 and to achieve good developer carrier performance in the axial direction of the developer roller 5 and absorb a desired amount of the developer thereon. Accordingly, it is able to prevent unevenness in density of a developed image in the axial direction of the developer roller 5 and a decrease in the density of developed images over time.

Moreover, with an improved developer carrier performance, the developer is prevented from remaining in the supply path 9 to thereby make the amount of the developer constant in the supply path 9, recovery path 7, and agitation path 10. This enables continuous developments.

Further, the magnetic pole 13 is disposed so that the position Q (upstream minimum magnetic flux density point) is to be closer to an upstream of a rotary direction I of the developer roller 5 than one end 133a of the first bulkhead 133. This enables the magnetic force from magnetic pole 13 to act on even a portion below the one end 133a of the first bulkhead 133 and attracts the developer to the outer surface of the developer roller 5. It is therefore preventable of a reduction of the amount of the developer in the supply path 9 due to a leakage from the gap between the one end 133a and the developer roller 5. Accordingly, it is able to prevent unevenness in density of a developed image in the axial direction of the developer roller 5 and a decrease in the density of developed images over time.

The mean particle size of the magnetic carrier in the developer is set to 20 μm or more and 50 μm or less so that developed images with good granularity and even density are obtainable.

Furthermore, the develop unit according to the present invention comprises the supply path 9 and the recovery path 7 to supply and recover the developer separately. This can prevent a used developer from flowing into the supply path 9, thereby preventing a gradual decrease in toner density of the developer supplied to the developer roller 5 towards the downstream of the carrier direction of the supply path 9. Also, the develop unit comprises the recovery path 7 and the agitation path 10 to recover and agitate the developer separately, thereby preventing a leakage of the used developer to the agitation path 10. Therefore, it is possible to prevent the developer insufficiently agitated from being supplied to the supply path 9 as well as to prevent a decrease in toner density of the developer, enabling supply of well-agitated developer to the supply path 9 and development of images with even density.

According to the present embodiment, the rotary axis of the supply screw 8 and the axis of the developer roller 5 are set to be in parallel with each other at the same height. However, the present invention is not limited thereto. The positions of the supply screw 8 and developer roller 5 is arbitrary as long as the above-described positional relation of the magnetic pole 13 and the supply screw 8 is maintained. Similarly, although the end 133a of the first bulkhead 133 is disposed at the same height as that of the axis of the developer roller 5 in the present embodiment, the present invention is not limited thereto. The positions of the two are arbitrary as long as the gap therebetween is set to prevent a leakage of the developer.

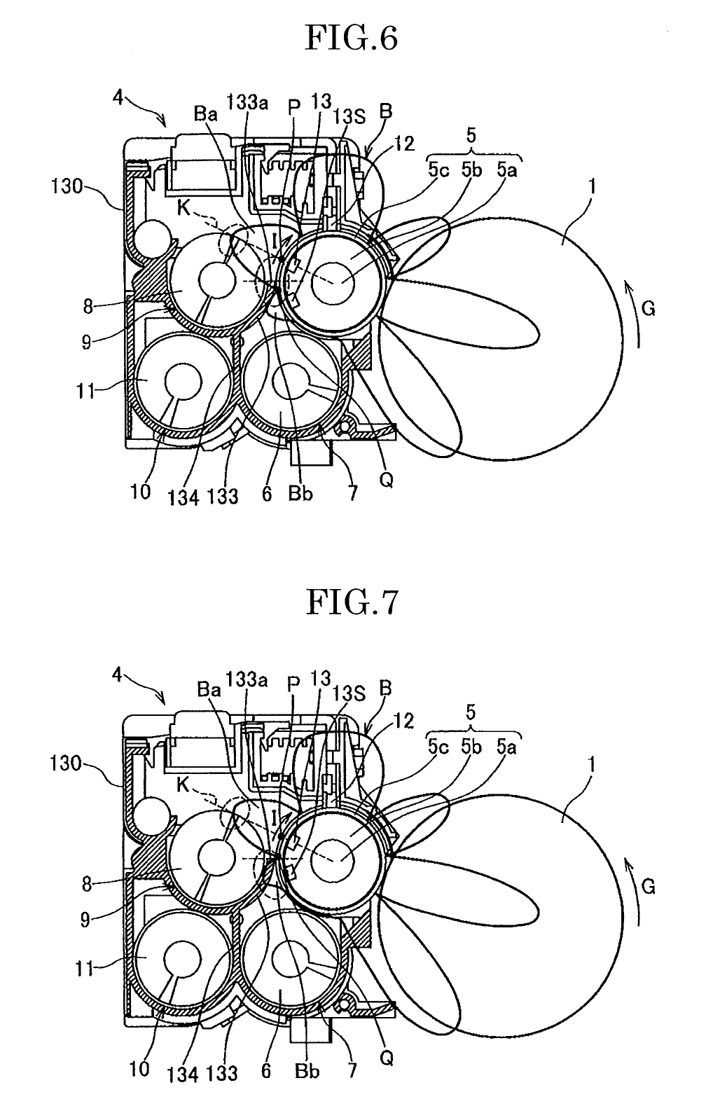

Further, according to the present embodiment, only the magnetic pole 13 is used for absorbing the developer onto the developer roller 5. However, an auxiliary magnetic pole 13S can be additionally provided at a position more upstream in the rotary direction I of the developer roller 5 than the end 133a of the first bulkhead 133 as shown in FIG. 6. The auxiliary magnetic pole 13S generates a magnetic flux density Bb and a magnetic force therefrom can act on a portion below the end 133a of the first bulkhead 133 and attract the developer onto the surface of the developer roller 5. This can prevent the developer from leaking form the gap between the end 133a and the developer roller 5, and prevent the amount of the developer from reducing in the supply path 9 due to the leakage accordingly. Also, it is possible to prevent a reduction in density of developed images over time. With the provision of the auxiliary magnetic pole 13S, the position Q (upstream minimum magnetic flux density point) is arbitrarily set.

Next, a process cartridge according to a second embodiment of the present invention will be described with reference to FIG. 4.

A process cartridge 18 comprises the develop unit 4 according to the first embodiment, a photoconductor drum 1 (image support body) disposed to face the developer roller 5 with a gap of approximately 0.3 mm and rotatably fixed to a case 140 of the process cartridge 18 to support an electrostatic latent image on its surface, an electric charger 142 uniformly charging the photoconductor drum 1, a not-shown cleaning device removing a toner from the photoconductor drum 1, a not-shown neutralizer removing remnant electric charges from the photoconductor drum 1, and so on.

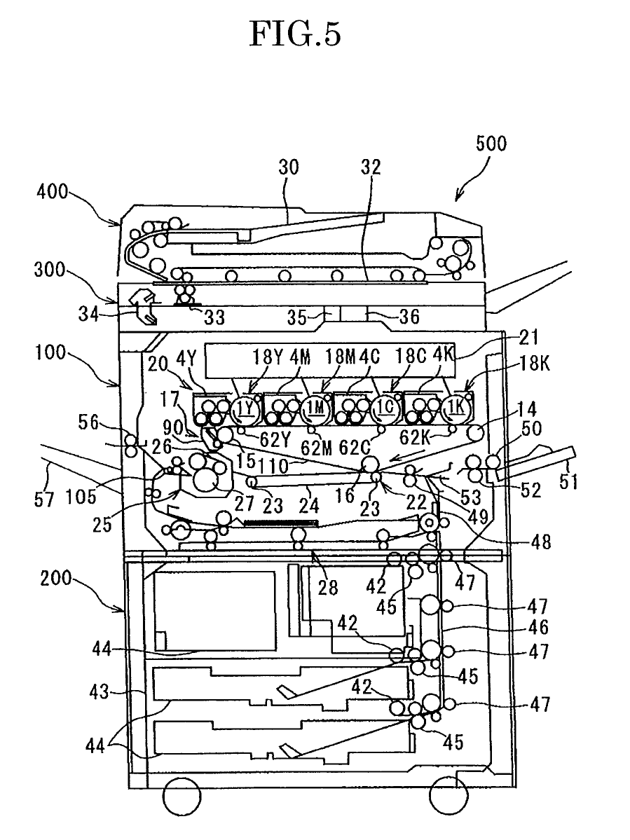

During image formation operation, in the process cartridge 18 the electric charger 142 uniformly charges a part of the surface of the photoconductor drum 1. A laser write unit 21 (FIG. 5) of an image formation apparatus incorporating the process cartridge 18 illuminates the charged part of the surface with a modulated and deflected laser beam. This causes an electric potential of the illuminated (exposed) part to be attenuated, thereby forming an electrostatic latent image on the surface of the photoconductor drum 1. The electrostatic latent image is developed to a toner image by the develop unit 4.

The process cartridge 18 primarily transfers the toner image on the surface of the photoconductor drum 1 to a later-described intermediate transfer belt 110. The cleaning device removes a remnant toner from the photoconductor drum 1 after the primary transfer. Then, the neutralizer removes a remnant electrostatic latent image from the photoconductor drum 1. The electric charger 142 uniformly charges the photoconductor drum 1 again and the above operation is repeated.

As described above, the process cartridge 18 according to the present invention is configured to include the develop unit 4 according to the first embodiment so that it can prevent unevenness in density of a developed image in the axial direction of the developer roller 5 and a reduction of the density of a developed image.

Next, an image formation apparatus according to a third embodiment of the present invention will be described with reference to FIG. 5, using a color laser copier 500 of a tandem type (hereinafter, copier) as a example.

FIG. 5 schematically shows a cross section of a copier 500. The copier 500 comprises a printer unit 100 which copies an image on paper, and a paper feeder 200 which feeds sheets of paper to the printer unit 100, a scanner 300 which reads an original document as an image, an automatic document feeder 400 which continuously feeds document sheets to the scanner 300 and so on.

The printer unit 100 comprises an image formation unit 20 incorporating four process cartridges 18Y, 18M, 18C, 18K to form images in yellow (Y), magenta (M), cyan (C), black (B). Note that hereinafter, units associated with the 4 colors will be given numeric codes with Y, M, C, K in ending. The printer unit 100 also comprises a laser write unit 21, an intermediate transfer unit 17, a secondary transfer unit 22, a resist roller pair 49, a belt-type fuser unit 25 and so on.

The laser write unit 21 comprises a light source, a polygon mirror, an fθ lens, a reflective mirror (not shown) and else to illuminate the surface of the photoconductor drum 1 with a laser beam.

The intermediate transfer unit 17 comprises an intermediate transfer belt 110, a support roller 14, a drive roller 15, a secondary transfer backup roller 16, four primary transfer bias rollers 62Y, 62M, 62C, 62K, and a belt cleaning device 90.

The intermediate transfer belt 110 is hung with a tension over a plurality of rollers including the support roller 14, a drive roller 15, a secondary transfer backup roller 16, and is endlessly moved by rotation of the drive roller 15 counterclockwise in the drawing

The four primary transfer bias rollers 62Y, 62M, 62C, 62K are disposed to contact with the inner circumference of the intermediate transfer belt 110 and be applied with a primary transfer bias by a not shown power source. The primary transfer bias rollers 62Y, 62M, 62C, 62K press the intermediate transfer belt 110 towards the photoconductor drums 1Y, 1M, 1C, 1K to form primary transfer nips, respectively. In each primary transfer nip, a primary transfer electric field is formed between each photoconductor drum and each primary transfer bias roller due to the primary transfer bias.

In the primary transfer nip (Y), a yellow toner image on the photoconductor drum 1Y is primarily transferred onto the intermediate transfer belt 110 due to the primary transfer electric field and a primary transfer nip pressure. Then, a magenta toner image on the photoconductor drum 1M, a cyan toner image on the photoconductor drum 1C, and a black toner image on the photoconductor drum 1K are superimposed on the yellow toner image in sequence. By this superimposing primary transfer, a four color toner image is formed on the intermediate transfer belt 110. The four color toner image is secondarily transferred onto not shown paper in a later-described secondary transfer nip.

The belt cleaning device 90 sandwiches the intermediate transfer belt 110 with the drive roller 15 to remove a remnant toner from the surface thereof after the secondary transfer nips pass.

The secondary transfer unit 22 comprises two support rollers 23 and a carrier belt 24 and is disposed below an intermediate transfer unit 17.

The carrier belt 24 is hang over the two support rollers 23 and endlessly moved counterclockwise in FIG. 5 by rotation of at least one of the support rollers 23.

One of the support rollers 23 on the right side of the drawing sandwiches the intermediate transfer belt 110 and the carrier belt 24 with the secondary transfer backup roller 16 and presses them. Here, secondary transfer nips are formed in which the intermediate transfer belt 110 and the carrier belt 24 get in contact with each other. The one support roller 23 is applied with a secondary transfer bias whose polarity is reverse to that of the toner by a not-shown power source. The applied bias causes a secondary transfer electric field to be formed in the secondary transfer nip. The secondary transfer electric field electrostatically transfers the four color toner image onto the intermediate transfer belt 110 of the intermediate transfer unit 17 to the one support roller 23.

The resist roller pair 49 carries paper to the secondary transfer nip in synchronization with the four color image on the intermediate transfer belt 11 and the four color toner image is secondarily transferred onto the paper due to the secondary transfer electric field and a secondary transfer nip pressure. Alternatively, an electric charger to charge paper in non-contact manner can be provided in replace of the support roller 23 being applied with the secondary transfer bias based on a secondary transfer method.

The paper feeder 200 is placed in the bottom of a copier body, and contains paper feed cassettes 44 disposed in a vertical direction, in which a plurality of sheets of paper are piled up. In each paper feed cassette 44, a feed roller 42 presses the uppermost sheet of paper and rotates to carry the uppermost sheet to a feed path 46.

The feed path 46 is a carrier path for receiving paper from the paper feed cassettes 44, and comprises a plurality of carrier roller pairs 47 and the resist roller pair 49 disposed near the end of the feed path. The carrier roller pairs 47 carry sheets of paper to the resist roller pair 49 in order to be placed between the resist roller pair 49.

In the intermediate transfer unit 17, the four color toner image is transferred to the secondary transfer nip along with the movement of the intermediate transfer belt 110. The resist roller pair 49 sends a paper sheet at a good timing to get the paper sheet in close contact with the four color toner image in the secondary transfer nip. The four color toner image is secondarily transferred to be a full color image on a white-color paper sheet. The paper sheet with the full color image thereon is sent to the fuser unit 25 along with movement of the carrier belt 24.

The fuser unit 25 comprises a belt unit endlessly moving a fuser belt 26 via two rollers, and a pressure roller 27 being pressed onto one of the two rollers. The fuser belt 26 and the pressure roller 27 are in contact with each other and form a fuse nip to place a paper sheet therein. The one roller pressed by the pressure roller 27 contains a not-shown heat source to heat up the fuser belt 26 which heats the paper sheet placed in the fuse nip. By the heat and pressure (fuse nip pressure), a full color toner image is fused on the paper sheet (fuse process).

After the fuse process, paper sheets are stuck on a paper stuck portion 57 protruding from a left-side plate of a printer housing in the drawing. For forming a toner image on another side of a paper sheet (double-sided copying), the paper sheet is transferred to the secondary transfer nip again.

Furthermore, the copier 500 comprises a not-shown controller composed of a CPU and the like to control the respective units inside, and an operation display unit composed of a liquid crystal display, various keys and buttons and else. An operator manipulates the operation display unit to give various instructions to the controller to set a printing mode of the printer unit 100 or make a copy, for example.

Next, copying with the copier 500 will be described.

For copying a not-shown original document with the copier 500, sheets of a document are set on a platen 30 of the automatic document feeder 400, for example. When the document is a bound document like a book, the automatic document feeder 400 is raised from the copier body and the document is placed on a contact glass 32 of the scanner 300. Then, the automatic document feeder is returned to the original position to press down the document.

Upon a press to a not-shown start switch, the scanner 300 starts a read operation to the document. With the document set on the platen 30, the automatic document feeder 400 automatically moves the document to the contact glass 32. In the read operation, first and second moving parts start moving together, and a light source in the first moving part 33 emits light to the document. A reflected light from the document is reflected by a mirror in the second moving part 34, passes through a focus lens 35, and is incident on a read sensor 36. The read sensor 36 obtains image information according to the incident light.

In parallel with the read operation, the respective units of the process cartridges 18Y, 18M, 18C, 18K, the intermediate transfer unit 17, the secondary transfer unit 22, and the fuser unit 25 start operating. According to the image information from the read sensor 36, the laser write unit 21 is controlled to emit a laser beam to the photoconductor drum 1Y, 1M, 1C, 1K, forming an electrostatic latent image thereon. The develop unit 4 develops toner images in four colors on the photoconductor drum 1Y, 1M, 1C, 1K, respectively. The toner images are superimposed and transferred onto the intermediate transfer belt 110 to form a four color toner image.

Almost at the same time with the start of the read operation, the paper feeder 200 starts a feed operation in which one of the feed rollers 42 is selectively rotated to extract sheets of paper from any of the paper feed cassettes 44 in a paper bank 43 and the separation roller separates the sheets of paper one by one to feed them to the feed path 46, and the carrier roller pair 47 carries them to the secondary transfer nip. The paper feed may be made via a manual paper feed tray 51 instead of the paper feed cassettes 44. In this case, a manual feed roller 50 is selectively rotated to take sheets of paper from the manual paper feed tray 51 into the copier 500, and the separation roller 52 separates them one by one to carry them to the secondary transfer nip via a manual feed path 53.

In the secondary transfer nip, the four color toner image on the intermediate transfer belt 110 is transferred onto the paper sheet, and then fed to the fuser unit 25. The fuser unit 25 fuses a full color image on the paper sheet by heating.

The copier 500 is configured to horizontally set the top surface of the intermediate transfer belt 110 so as to be in contact with the all the photoconductor drums 1Y, 1M, 1C, 1K for multi-color image formation of two color toners or more. Meanwhile, for monochrome image formation of black color toner only, the copier 500 tilts the intermediate transfer belt 110 with a not-shown mechanism in a lower left direction in the drawing so as to separate the top surface from the photoconductor drums 1Y, 1M, 1C. Then, only the photoconductor drum 1K is rotated counterclockwise to form a black toner image while the rest of the photoconductor drums and the develop units for the other colors are stopped. Thereby, unnecessary consumption of the developer and the photoconductors is avoided.

As described above, the copier 500 as an image formation apparatus according to the present invention is configured to include the process cartridges 18 so that it is possible to prevent unevenness in the density of a developed image in the axial direction of the developer roller 5 and a decrease in the density of developed images.

In order to confirm the effects of the present invention, the inventors thereof prepared a plurality of develop units in different structures in terms of a position of the magnetic pole 13 and presence/absence of the auxiliary magnetic pole 13S. Then, they developed solid images with the develop units to evaluate unevenness in densities of initial solid images and a decrease in densities of non-initial solid images over time.

The results were evaluated as follows. For density unevenness evaluation, first, an initial solid image was developed (printed) by each develop unit, and density was measured at a plural points in each solid image to obtain a mean value. Then, a determination was made on whether or not the obtained mean density is equal to or exceeds a predetermined density. Also, a difference between a point in a thickest density and a point in a thinnest density in the axial direction of the developer roller 5 was calculated. For density decrease evaluation, an initial solid image and a non-initial solid image after developments of 30,000 sheets of paper were compared by measuring the densities of plural points of each solid image to calculate a mean value and a decrease in the density of the non-initial solid image from that of the initial solid image.

Evaluation criteria are as follows:
Unevenness in density
   ◯: Mean Density≧Predetermined Density AND (Thickest Density−Thinnest Density)≦20%
   Δ: Mean Density<Predetermined Density AND (Thickest Density−Thinnest Density)≦20%
   ×: (Thickest Density−Thinnest Density)>20%
Decrease in density from initial to non-initial solid images
   ⊚: decrease≦5%
   ◯: 5%<decrease>10%
   ×: decrease>10%

### FIRST EXAMPLE

In FIG. 1, the magnetic pole 13 is disposed so that a normal line K through a position P (maximum magnetic flux density point) in a circumferential direction of the developer roller 5 coincides with a tangent line to an upper portion of the supply screw 8 in a rotary direction, as well as that a position Q (upstream minimum magnetic flux density point) is to be closer to an upstream of a rotary direction I of the developer roller 5 than one end 133a of the first bulkhead 133. The auxiliary magnetic pole 13S is not provided.

### SECOND EXAMPLE

In FIG. 6, the magnetic pole 13 is disposed so that the normal line K through the position P in the circumferential direction of the developer roller 5 coincides with a tangent line to an upper portion of the supply screw 8 in the rotary direction, as well as that the position Q is to be closer to an upstream of the rotary direction I of the developer roller 5 than the one end 133a of the first bulkhead 133. Also, the auxiliary magnetic pole 13S is disposed adjacent to the magnetic pole 13 on an upstream side of the rotary direction I.

### THIRD EXAMPLE

In FIG. 7 the magnetic pole 13 is disposed so that the normal line K through the position P in the circumferential direction of the developer roller 5 coincides with a tangent line to an upper portion of the supply screw in the rotary direction, as well as that the position Q is to be closer to a downstream of the rotary direction I of the developer roller 5 than the one end 133a of the first bulkhead 133. Also, the auxiliary magnetic pole 13S is disposed adjacent to the magnetic pole 13 on an upstream side of the rotary direction I.

### FOURTH EXAMPLE

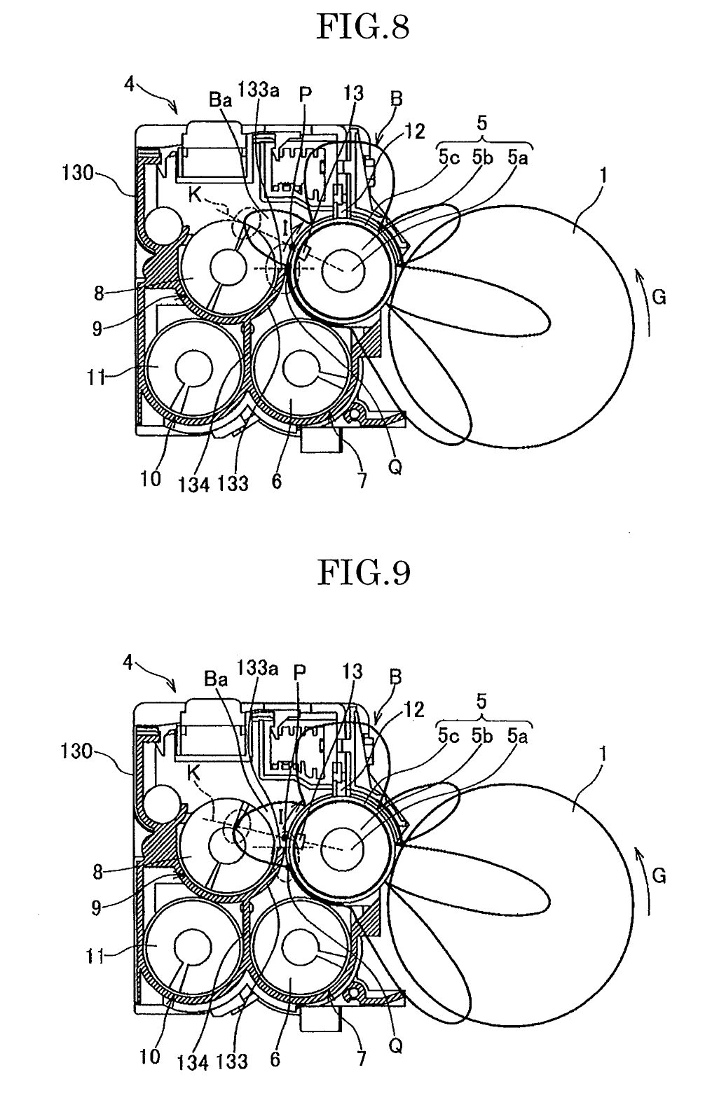

In FIG. 8, the magnetic pole 13 is disposed so that the normal line K through the position P in the circumferential direction of the developer roller 5 coincides with a tangent line to an upper portion of the supply screw 8 in the rotary direction, as well as that the position Q is to be closer to a downstream of the rotary direction I of the developer roller 5 than the one end 133a of the first bulkhead 133. The auxiliary magnetic pole 13S is not provided.

### FIRST COMPARISON

In FIG. 9, the magnetic pole 13 is disposed so that the normal line K through the position P in the circumferential direction of the developer roller 5 goes inside of a tangent line to an upper portion of the supply screw 8 in the rotary direction, as well as that the position Q is to be closer to an upstream of the rotary direction I of the developer roller 5 than the one end 133a of the first bulkhead 133. The auxiliary magnetic pole 13S is not provided.

### SECOND COMPARISON

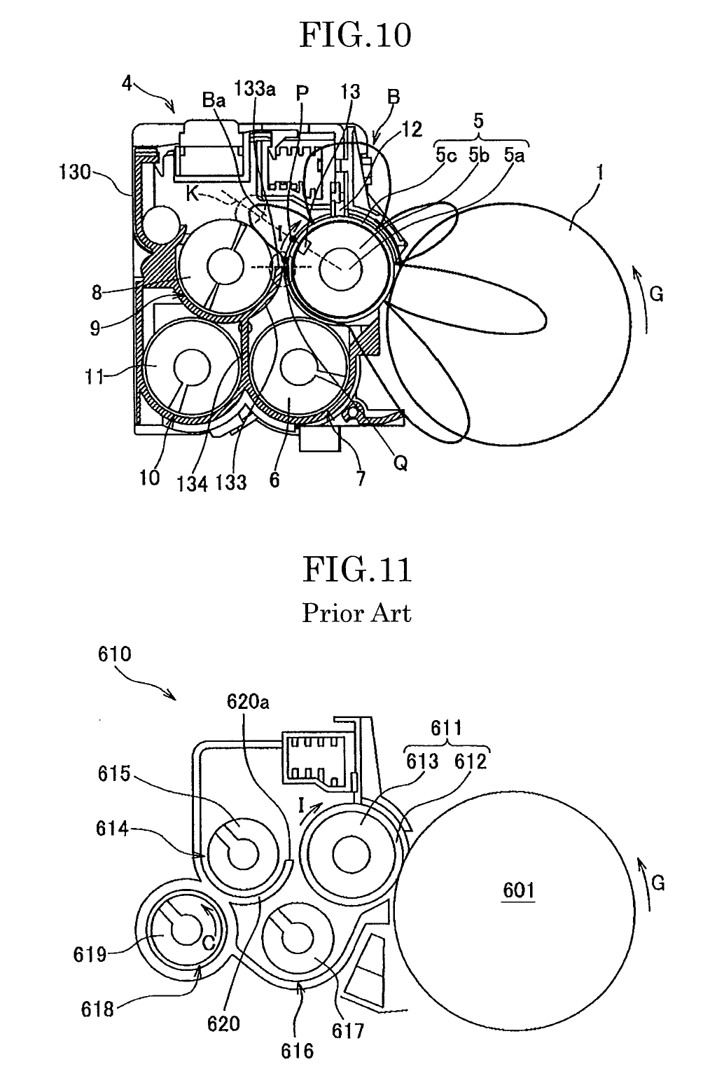

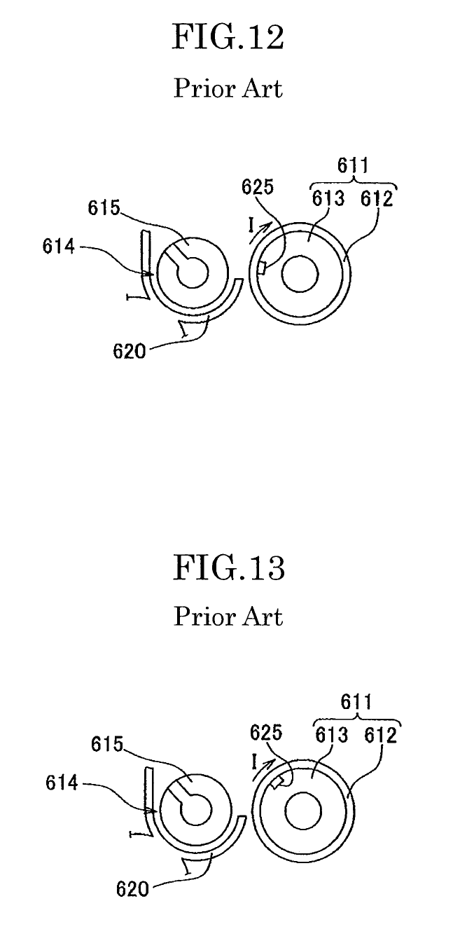

In FIG. 10, the magnetic pole 13 is disposed so that the normal line K through the position P in the circumferential direction of the developer roller 5 goes outside of a tangent line to an upper portion of the supply screw 8 in the rotary direction, as well as that the position Q is to be closer to a downstream of the rotary direction I of the developer roller 5 than the one end 133a of the first bulkhead 133. The auxiliary magnetic pole 13S is not provided.

The table 1 shows the results of each Example.

TABLE 1

| | Develop Unit | | | Evaluation | |
|---|---|---|---|---|---|
| | Normal Line K | Position Q | Auxiliary Magnetic Pole | Unevenness | Decrease |
| 1st Example | Coincident with tangent line | Upstream of one end | None | ◯ | ◯ |
| 2st Example | Coincident with tangent line | Upstream of one end | Provided | ◯ | ⊚ |
| 3st Example | Coincident with tangent line | Downstream of one end | Provided | ◯ | ⊚ |
| 4st Example | Coincident with tangent line | Downstream of one end | None | ◯ | X |
| 1st Comparison | Inside tangent line | Upstream of one end | None | X | — |
| 2st Comparison | Outside tangent line | Downstream of one end | None | Δ | X |

From the results obtained in the first to fourth examples and the first and second comparisons, it can be concluded that when the magnetic pole 13 is disposed with the normal line K through the position P coinciding with the tangent line, the density of a developed image is equal to/over the predetermined density and sufficiently even in the axial direction of the developer roller 5. The unevenness increases when the magnetic pole 13 is disposed closer to the rotary axis of the supply screw 8, that is, the normal line K is inside the tangent line, because of a decrease in the developer carrier performance. On the contrary, with the magnetic pole 13 distant away from the rotary axis of the supply screw 8, or the normal line K outside the tangent line, the developer carrier performance is improved to eliminate unevenness in the density, however, the amount of developer absorbed on the developer roller 5 is decreased, resulting in a developed image with a weak density below the predetermined density. Accordingly, it is confirmed that disposing the magnetic pole 13 with the normal line K through the position P (maximum magnetic flux density point) coinciding with the tangent line makes it possible to achieve a good developer carrier performance and a sufficient amount of the developer absorbed onto the developer roller 5 at the same time. Further, it is possible to obtain developed images with a good density without unevenness.

Further, it can be seen from the results from the first and fourth examples that without the auxiliary magnetic pole 13S, a decrease in the density of the non-initial solid image (after printing 30,000 sheets of paper) is avoided when the magnetic pole 13 is disposed so that the position Q (upstream minimum magnetic flux density point) is to be closer to the upstream of the rotary direction I of the developer roller 5 than the one end 133a of the first bulkhead 133. Oppositely, when the magnetic pole 13 is disposed so that the position Q comes downstream of the rotary direction I, the amount of the developer is gradually decreased in the supply path 9, causing over a 10% decease in density of the non-initial solid images. Accordingly, it is confirmed that disposing the magnetic pole 13 with the position Q closer to the upstream of the rotary direction I than the one end 133a makes it possible to achieve a decrease in the amount of the developer in the supply path 9 and to prevent a temporal density reduction in the developed images.

Further, it can be seen from the results from the second and third embodiments that with the auxiliary magnetic pole 13S provided adjacent to the magnetic pole 13 on the upstream side of the rotary direction I, a density reduction in the non-initial solid image is avoided irrespective of the location of the position Q. Accordingly, it is confirmed that with the provision of the auxiliary magnetic pole 13S, it is able to achieve a decrease in the amount of the developer in the supply path 9 and to prevent a temporal density reduction in the developed images.

As described above, disposing the magnetic pole 13 so that the normal line K through the position P (maximum magnetic flux density point) coincides with the tangent line makes it possible to prevent unevenness in the density of a developed image in the axial direction of the developer roller 5 and produce developed images with the predetermined density. Further, disposing the magnetic pole 13 so that the position Q is closer to the upstream of the rotary direction I than the one end 133a makes it possible to prevent a temporal density decrease in the developed images. Also, with the provision of the auxiliary magnetic pole 13S, it is able to prevent a temporal density decrease in developed images irrespective of the location of the position Q.

Although the present invention has been described in terms of exemplary embodiments, it is not limited thereto. It should be appreciated that variations may be made in the embodiments described by persons skilled in the art without departing from the scope of the present invention as defined by the following claims.

What is claimed is:

1. A develop unit comprising:
a developer support body comprising a cylindrical hollow body supporting a developer on its outer surface, a magnetic field generator contained in the hollow body and including a magnetic pole absorbing the developer onto the outer surface, the developer being made of a toner and a magnetic carrier;
a developer supply path formed in parallel with an axial direction of the developer support body;
a developer supply member disposed in the developer supply path and rotating to carry and supply the developer to the developer support body in the axial direction; and
a bulkheading member forming the developer supply path with one end extending along the developer support body with a gap, wherein
the magnetic pole is disposed in the magnetic field generator so that a normal line through a maximum magnetic flux density point in a circumferential direction coincides with a tangent line to an upper portion of the developer supply member in a rotary direction, the maximum magnetic flux density point being a point at which a density of a magnetic flux from the magnetic pole is maximum on an outer surface of the hollow body.

2. A develop unit according to claim 1, wherein
the magnetic pole is disposed in the magnetic field generator so that an upstream minimum magnetic flux density point is to be closer to an upstream of a rotary direction of the developer support body than one end of the bulkheading member, the upstream minimum magnetic flux density point being one of minimum magnetic flux density points at an upstream of the rotary direction of the developer support body, the minimum magnetic flux density points being points at which densities of magnetic fluxes from the magnetic pole are minimum on the outer surface of the hollow body.

3. A develop unit according to claim 1, wherein the magnetic field generator comprises an auxiliary magnetic pole disposed at a position closer to the upstream of the rotation direction of the developer support body than one end of the bulkheading member.

4. A develop unit according to claim 1, wherein a mean particle size of the magnetic carrier is 20 μm or more and 50 μm or less.

5. A process cartridge comprising the develop unit according to claim 1.

6. An image formation apparatus comprising one or more process cartridge(s) according to claim 5.
